(19) United States
(12) Patent Application Publication
(10) Pub. No.: US 2022/0337003 A1
(43) Pub. Date: Oct. 20, 2022

(54) METHOD FOR CONNECTING CABLE TO CONNECTOR, AND CABLE CONNECTED TO CONNECTOR

(71) Applicant: NANCHANG UNITETEC TECHNOLOGY CO., LTD., Nanchang, Jiangxi (CN)

(72) Inventor: Tianwei YANG, Nanchang, Jiangxi (CN)

(73) Assignee: NANCHANG UNITETEC TECHNOLOGY CO., LTD., Nanchang, Jiangxi (CN)

(21) Appl. No.: 17/627,813

(22) PCT Filed: Aug. 15, 2019
(86) PCT No.: PCT/CN2019/100686

§ 371 Date: Jun. 28, 2022

(30) Foreign Application Priority Data
Jul. 22, 2019 (CN) 201910663072.7

(51) Int. Cl. H01R 13/6592; H01B 7/18; H01B 13/26; H01R 43/28

(52) U.S. Cl. CPC H01R 13/6592; H01B 7/1875; H01B 13/26; H01R 43/28

(57) ABSTRACT

A method for connecting a cable to a connector (1001), and a cable connected to the connector (1001), for use in improving an anti-interference capability at a position where the cable is connected to the connector (1001) and between cable core conductors (1002), thereby improving a transmission rate and transmission power of a cable having a connector. The method of embodiments comprises: baring a preset length of a cable core conductor (1002) in a cable; connecting the cable core conductor (1002) to a connector (1002); cladding the connected bare cable core conductor (1002) using an electromagnetic shielding film (1003) to effectively reduce signal crosstalk between cable cores, the electromagnetic shielding film (1003) at least comprising a first metal layer (A), a conductive layer (B), and a protective film (C), wherein the first metal layer (A) is used for shielding electromagnetic interference, the conductive layer (B) is provided on the first metal layer (A) to shield electromagnetic interference, and the protective film (C) is provided on the conductive layer (B) to provide protection to the electromagnetic shielding film (1003).

The present application claims priority of Chinese Patent Application No. 201910663072.7, titled “METHOD FOR CONNECTING CABLE TO CONNECTOR, AND CABLE CONNECTED TO CONNECTOR”, filed with the China National Intellectual Property Administration on Jul. 22, 2019, which is incorporated herein by reference in its entirety.

### FIELD

The present application relates to the technical field of cable connection, and in particular to a method for connecting a cable to a connector, and the cable connected to the connector.

### BACKGROUND

In the prior art, when a cable is connected to a connector, a cable core conductor is generally connected to the connector, and a bare cable core is wrapped by metal braiding to form an electromagnetic shielding layer of the cable core conductor. However, this shielding method can only be enhanced by multi-layer braiding, which on the one hand increases the diameter of the wrapped cable is and worsens the flexibility of the cable, and on the other hand increases the production cost.

With the advent of 5G communication, a signal transmission line not only needs to meet the requirement of high-speed transmission (10 Gpbs), but also needs to have a charging power greater than 100 W when realizing fast charging of a terminal. While the requirements of high-speed and high-power require a stronger anti-interference capability of signal transmission between cable cores. However, the current shielding method between the cable core conductor and the connector by multi-layer braiding cannot meet the anti-interference requirements of high-speed and high-power transmission.

### SUMMARY

A method for connecting a cable to a connector and the cable connected to the connector are provided according to the present application, so as to improve the anti-interference capability at a connection between the cable and the connector, and between the cable core conductors, thereby improving the transmission speed and transmission power of the cable with the connector.

A first aspect of the embodiments of the present application provides a method for connecting a cable to a connector, and the method includes:

baring a cable core conductor with a predetermined length in the cable;

connecting the cable core conductor to the connector;

wrapping the connected bare cable core conductor with an electromagnetic shielding film to effectively reduce signal crosstalk between cable cores, where the electromagnetic shielding film includes at least a first metal layer, a conductive layer and a protective film;

the first metal layer is configured to shield electromagnetic interference;

the conductive layer is arranged on the first metal layer, and is configured to shield electromagnetic interference; and

the protective film is arranged on the conductive layer, and is configured to provide protection for the electromagnetic shielding film.

Preferably, the wrapping the connected bare cable core conductor with the electromagnetic shielding film includes:

wrapping the electromagnetic shielding film on a connection between the cable core conductor and the connector.

Preferably, the wrapping the connected bare cable core conductor with the electromagnetic shielding film includes:

arranging the electromagnetic shielding film between the cable core conductors of a pair of cable core groups in the cable; and

wrapping the cable core conductors with the electromagnetic shielding film.

Preferably, the wrapping the connected bare cable core conductor with the electromagnetic shielding film includes:

wrapping the electromagnetic shielding film on an outer side of each cable core conductor in the cable.

Preferably, the method further includes:

fixing the electromagnetic shielding film by a fixing device.

Preferably, the fixing device is a tinplate.

A second aspect of the embodiments of the present application provides a cable connected to a connector, and the cable is made by the method described in the first aspect of the embodiments of the present application, and the cable includes:

a connector, a bare cable core conductor connected to the connector;

and an electromagnetic shielding film, where the electromagnetic shielding film is configured to wrap the bare cable core conductor.

Preferably, the electromagnetic shielding film is configured to wrap on a connection between the cable core conductor and the connector.

Preferably, the electromagnetic shielding film is arranged between the cable core conductors of a pair of cable core groups in the cable to wrap the cable core conductors.

Preferably, the electromagnetic shielding film is configured to wrap on an outer side of each cable core conductor in the cable.

Preferably, the cable further includes a fixing device for fixing the electromagnetic shielding film.

Preferably, the fixing device is a tinplate.

It can be seen from the above technical solutions that, advantages of the embodiments of the present application are as follows.

In the embodiments of the present application, the cable core conductor with the predetermined length in the cable is bared; the cable core conductor is connected to the connector; the connected bare cable core conductor is wrapped with the electromagnetic shielding film to effectively reduce signal crosstalk between cable cores, where the electromagnetic shielding film includes at least the first metal layer, the conductive layer and the protective film; the first metal layer is configured to shield electromagnetic interference; the conductive layer is arranged on the first metal layer, and is configured to shield electromagnetic interference; the protective film is arranged on the conductive layer, and is configured to provide protection for the electromagnetic shielding film. Since in the embodiments of the present application, the connection between the cable core conductor and the connector is wrapped by the electromagnetic shielding film, the first metal layer and the conductive layer in the electromagnetic shielding film are respectively served as a first conductive layer and a second conductive layer, which not only facilitates longitudinally guiding electromagnetic waves out, that is, facilitates the longitudinal attenuation of the electromagnetic waves. Moreover, the first metal layer and the conductive layer are laterally conducted to form a loop for guiding the electromagnetic waves out, which also facilitates the lateral attenuation of the electromagnetic waves, so that the anti-interference capability between the cable cores is improved.

### BRIEF DESCRIPTION OF THE DRAWINGS

FIG. 1 is a schematic view of an embodiment of a method for connecting a cable to a connector provided according to an embodiment of the present application;

FIG. 2 shows a detailed step of a step 103 in an embodiment of FIG. 1 provided according to an embodiment of the present application;

FIG. 3A is a schematic view of a wrapping method in an embodiment of FIG. 2;

FIG. 3B is a schematic view of a comparison of electromagnetic shielding effect between the cable in the embodiment of FIG. 2 and a cable in the prior art;

FIG. 4 shows another detailed step of the step 103 in the embodiment of FIG. 1 provided according to an embodiment of the present application;

FIG. 5A is a schematic view of a wrapping method in an embodiment of FIG. 4;

FIG. 5B is a schematic view of a comparison of electromagnetic shielding effect between the cable in the embodiment of FIG. 4 and the cable in the embodiment of FIG. 2;

FIG. 6 shows another detailed steps of the step 103 in the embodiment of FIG. 1 provided according to an embodiment of the present application;

FIG. 7A is a schematic view of a wrapping method in an embodiment of FIG. 6;

FIG. 7B is a schematic view of a comparison of electromagnetic shielding effect between the cable in the embodiment of FIG. 6 and the cable in the embodiment of FIG. 4;

FIG. 8 is a schematic view of another embodiment of the method for connecting the cable to the connector provided according to an embodiment of the present application;

FIG. 9 is a schematic structural view of an electromagnetic shielding film provided according to an embodiment of the present application;

FIG. 10 is a schematic view of the cable connected to the connector provided according to an embodiment of the present application;

FIG. 11A is a schematic view of a comparison of anti-interference capability between a 24-core industrial control data line using the connection method provided according to the embodiment and a 24-core industrial control data line in the prior art;

FIG. 11B is a schematic view of a comparison of anti-interference capability between an HDMI data transmission line using the connection method provided according to the embodiment and an HDMI data transmission line in the prior art; and

FIG. 11C is a schematic view of a comparison of anti-interference capability between an USB 3.1 data and power transmission line using the connection method provided according to the embodiment and an USB 3.1 data and power transmission line in the prior art.

### DETAILED DESCRIPTION OF THE EMBODIMENTS

A method for connecting a cable to a connector and the cable connected to the connector are provided according to the present application, so as to improve the anti-interference capability at a connection between the cable and the connector, and between the cable core conductors, thereby improving the transmission speed and transmission power of the cable with the connector.

The technical solutions in the embodiments of the present application are described clearly and completely in conjunction with the drawings in the embodiments of the present application hereinafter, so that those skilled in the art can understand the technical solutions of the present application better. It is apparent that the described embodiments are only some rather than all embodiments of the present application. Any other embodiments obtained by those skilled in the art based on the embodiments in the present application without any creative effort shall fall within the protection scope of the present application.

Terms “first”, “second”, “third”, “fourth” and the like (if any) in the specification and claims of the present application and the above drawings are used to distinguish similar objects, and are not necessarily used to describe a specific order or sequence. It should be understood that the data used in this way may be interchangeable under an appropriate condition, so that the embodiments described herein can be implemented in an order other than those illustrated or described herein. In addition, terms “including” and “comprising” and any variations thereof are intended to be non-exclusive. For example, a process, method, system, product, or device that includes a series of steps or units is not necessarily limited to those clearly listed, but may include other steps or units that are not clearly listed or are inherent to the process, method, product, or device.

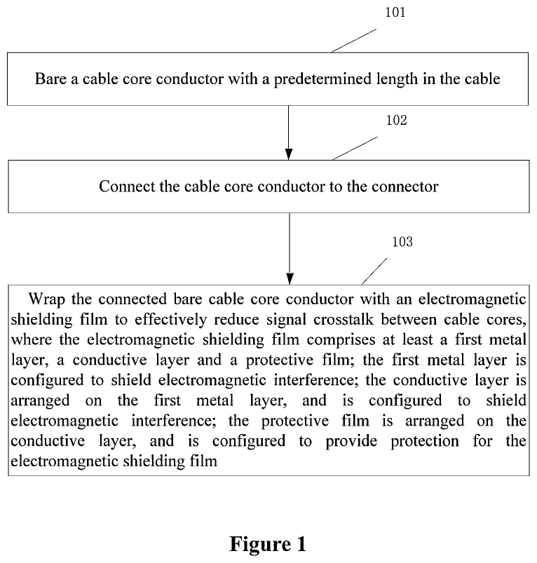

In order to facilitate understanding, a method for connecting a cable to a connector provided according to the present application is described as follows. Referring to FIG. 1, which shows an embodiment of the method for connecting the cable to the connector provided according to the embodiments of the present application, and the method includes the following steps 101 to 103.

In 101, a cable core conductor with a predetermined length in the cable is bared.

In order to realize the electrical connection between the cable and the connector, a conductor part of the cable core in the cable needs to be bared, so as to connect the cable core conductor to the connector.

In 102, the cable core conductor is connected to the connector.

When the cable core conductor is connected to the connector, welding, crimping, clipping or plugging may be used. Generally, the connection method between the cable core conductor and the connector depends on the connection requirements of the connector, which will not be specifically limited herein.

In 103, the connected bare cable core conductor is wrapped with an electromagnetic shielding film to effectively reduce signal crosstalk between cable cores, where the electromagnetic shielding film includes at least a first metal layer, a conductive layer and a protective film; the first metal layer is configured to shield electromagnetic interference; the conductive layer is arranged on the first metal layer, and is configured to shield electromagnetic interference; the protective film is arranged on the conductive layer, and is configured to provide protection for the electromagnetic shielding film.

Different from the prior art, after the cable core conductor is connected to the connector, the bare cable core is wrapped by metal braiding. Since the braided metal has meshes, the shielding rate is relatively low, which cannot meet the requirements of high speed and high power transmission. In the embodiment of the present application, the electromagnetic shielding film is used to wrap the connected bare cable core conductor, which effectively reduces the signal crosstalk between the cable cores, and improves the signal transmission rate and signal transmission power between the cable cores.

Specifically, the electromagnetic shielding film in the embodiment of the present application at least includes a first metal layer A, a conductive layer B, and a protective film C. Preferably, the first metal layer A is composed of at least one of gold, silver, copper, nickel, or aluminum. Since the first metal layer A serves as the first shielding layer, the requirement of conductivity is high, so the first metal layer A may be selected from several metals with better conductivity, such at least one of gold, silver, copper, nickel or aluminum, or an alloy of at least two of above metals.

Optionally, the thickness of the first metal layer A ranges from 3 to 50 micrometers, and the thickness of the first metal layer is selected according to different cables. The larger the diameter of the cable is, the larger the thickness of the first metal layer is selected. The smaller the diameter of the cable is, the smaller the thickness of the first metal layer is selected. According to different actual cable diameters, the thickness of the first metal layer can be customized.

The conductive layer B is arranged on the first metal layer A and is also configured to shield the electromagnetic interference. The conductive layer B includes metal particles and polyurethane, where metal particles play a conductive role, and the polyurethane as a carrier for carrying the metal particles is configured to fix the metal particles. Due to the positional relationship between the conductive layer B and the first metal layer A, electromagnetic waves can propagate rapidly along an axial direction of the cable core conductor on one hand, that is, the longitudinal attenuation of the electromagnetic waves is achieved, and the electromagnetic waves can also propagate rapidly along a radial direction of the cable core conductor on the other hand, that is, the lateral attenuation of the electromagnetic waves is achieved, so that the anti-interference capability of the cable core is improved.

The protective film C, as the last layer of the electromagnetic shielding film, is arranged on an outer side of the conductive layer B to protect the electromagnetic shielding film. Preferably, the protective film is generally a wear-resistant, waterproof, and electrical insulation engineering film, such as a polyimide PI film, or polypropylene PP film, or polyethylene PE film, or polyethylene terephthalate PET film, and the composition of the protective film is not specifically limited here.

In the embodiment of the present application, the cable core conductor with the predetermined length in the cable is bared; the cable core conductor is connected to the connector. The connected bare cable core conductor is wrapped with the electromagnetic shielding film to effectively reduce signal crosstalk between cable cores. The electromagnetic shielding film includes at least the first metal layer, the conductive layer and the protective film; the first metal layer is configured to shield electromagnetic interference; the conductive layer is arranged on the first metal layer, and is configured to shield electromagnetic interference; the protective film is arranged on the conductive layer, and is configured to provide protection for the electromagnetic shielding film. Since in the embodiments of the present application, the connection between the cable core conductor and the connector is wrapped with the electromagnetic shielding film, the first metal layer and the conductive layer in the electromagnetic shielding film are respectively served as a first conductive layer and a second conductive layer, which not only facilitates longitudinally guiding electromagnetic waves out, that is, facilitates the longitudinal attenuation of electromagnetic waves. Moreover, the first metal layer and the conductive layer are laterally conducted to form a loop for guiding the electromagnetic waves out, which also facilitates the lateral attenuation of electromagnetic waves, so that the anti-interference capability between the cable cores is improved.

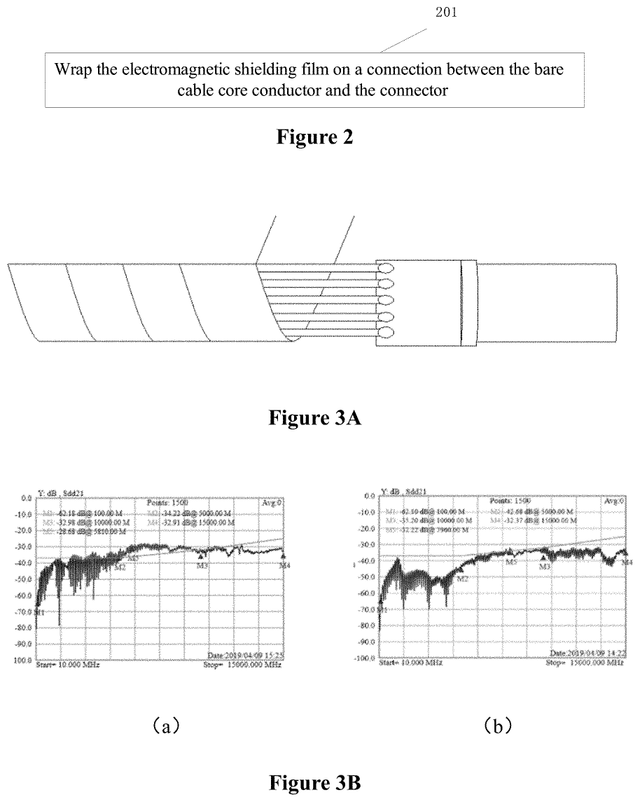

Based on the embodiment described in FIG. 1, the method of wrapping the connected bare cable core conductor with the electromagnetic shielding film is described in detail as follows. Referring to FIG. 2, which shows a detailed step of the step 103 in the embodiment of FIG. 1.

In 201, the electromagnetic shielding film is wrapped on a connection between the cable core conductor and the connector.

In order to clarify the wrapping method of the electromagnetic shielding film on the bare cable core conductor, FIG. 3A shows a schematic view of the wrapping method in the embodiment of FIG. 2. Specifically, when the bare cable core conductor is connected to the connector by welding, as shown in FIG. 3, the electromagnetic shielding film is directly wrapped on the connection between the bare cable core conductor and the connector, that is, the electromagnetic shielding film is wrapped on a welding point between the cable core conductor and the connector.

If the cable core is connected to the connector by clipping, crimping or plugging, the electromagnetic shielding film is respectively wrapped at a clipping, crimping or plugging position between the cable core conductor and the connector, so that the bare cable core conductor is fully and completely wrapped by the electromagnetic shielding film to minimize the electromagnetic interference between the cable cores.

In order to illustrate the improvement of anti-interference capability brought by wrapping the electromagnetic shielding film on the connection between the cable core conductor and the connector in the embodiment of the present application, FIG. 3B shows a schematic view of a comparison of anti-interference capability between a cable in the embodiment of the present application and a cable in the prior art, where Figure (a) is the anti-interference capability of the cable in the prior art, and Figure (b) is the anti-interference capability of the cable in the embodiment of FIG. 2.

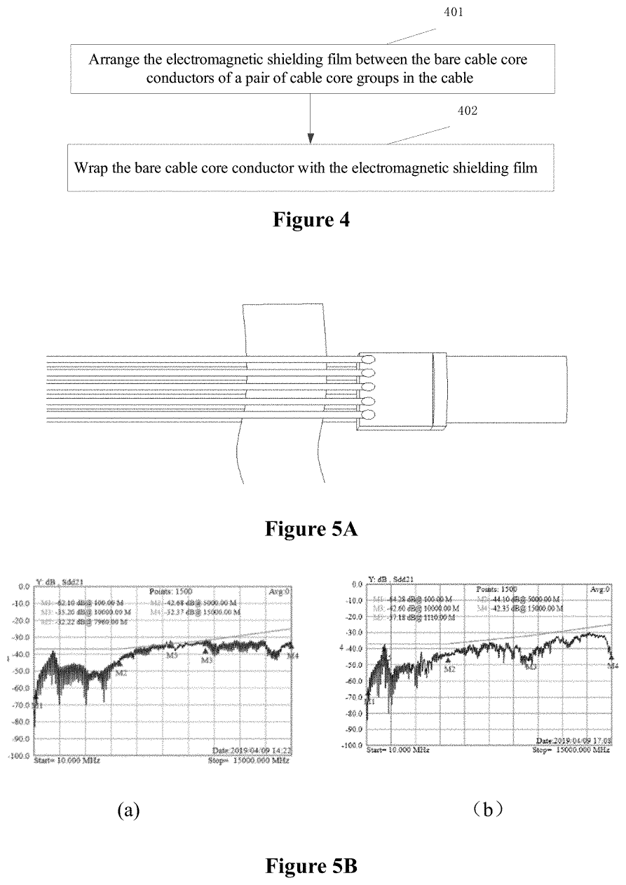

Based on the embodiment described in FIG. 1, the method of wrapping the connected bare cable core conductor with the electromagnetic shielding film is described in detail as follows. Referring to FIG. 4, which shows another detailed steps of the step 103 in the embodiment of FIG. 1.

In 401, the electromagnetic shielding film is arranged between the cable core conductors of a pair of cable core groups in the cable.

In order to more effectively accelerate the attenuation of the electromagnetic waves around each cable core, while considering the diameter of the wrapped cable core and the production cost, the electromagnetic shielding film in the embodiment of the present application can also be arranged between the cable core conductors of the pair of cable core groups in the cable. Specifically, reference may be made to FIG. 5A for a schematic arrangement view. Since when the cable core conductor is connected to the connector, two sides of the connector are generally symmetrical, the electromagnetic shielding film can be arranged between the bare cable core conductors of the pair of cable core groups in the cable for more effectively accelerating the attenuation of the electromagnetic waves, which accelerates the attenuation of the electromagnetic waves in both the radial direction and the axial direction of the cable core conductors located on the same side of the connector, and improves the anti-interference capability of the cable cores.

In 402, the bare cable core conductor is wrapped with the electromagnetic shielding film.

The electromagnetic shielding film is arranged between the bare cable core conductors of the pair of cable core groups in the cable, and the electromagnetic shielding film is used to wrap two layers of the cable core conductors of the pair cable core groups, so that a circumference of the cable core conductors on the same side of the connector is wrapped by the electromagnetic shielding film, which accelerates the radial attenuation and axial attenuation of the electromagnetic waves around the cable core conductors on the same side, and further improves the anti-interference capability of the core conductors.

Preferably, in order to reduce the diameter of the clapped cable, the electromagnetic shielding film in the embodiment may is a film thinner than the film in the embodiment of FIG. 2 to reduce the diameter of the clapped cable and improve the flexibility of the cable.

In order to illustrate the improvement of anti-interference capability brought by the clapping method in the embodiment of FIG. 4, FIG. 5B shows a schematic view of a comparison of anti-interference capability between the cable in the embodiment of FIG. 4 and the cable in the embodiment of FIG. 2, where Figure (a) is the anti-interference capability of the cable in the embodiment of FIG. 2, and Figure (b) is the anti-interference capability of the cable in the embodiment of FIG. 4.

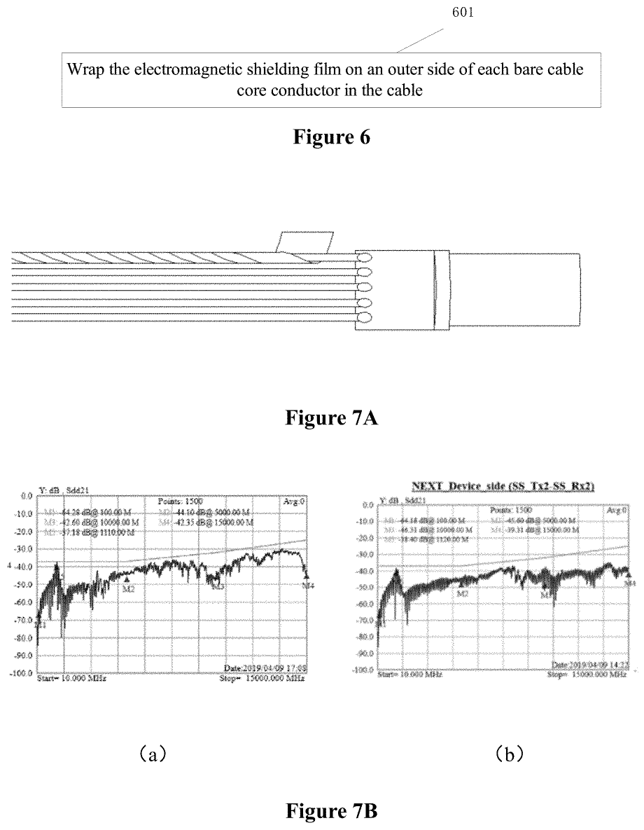

Based on the embodiment described in FIG. 1, the method of wrapping the connected bare cable core conductor with the electromagnetic shielding film is described in detail as follows. Referring to FIG. 6, which shows another detailed step 601 of the step 103 in the embodiment of FIG. 1.

In 601, the electromagnetic shielding film is wrapped on an outer side of each bare cable core conductor in the cable.

In order to further improve the anti-interference capability of the cable core, the electromagnetic shielding film can also be wrapped on the outer side of each bare cable core conductor in the cable. Reference may be made to FIG. 7A for the specific schematic wrapping view. The electromagnetic shielding film is wrapped on the outer side of each cable core conductor, which is equivalent to accelerating the axial attenuation and radial attenuation of the electromagnetic waves around each cable core, thereby further improving the anti-interference capability of the core conductors.

Preferably, in order to reduce the diameter of the wrapped cable, the electromagnetic shielding film in the embodiment may be a film thinner than the film in the embodiment of FIG. 4 to reduce the diameter of the wrapped cable and improve the flexibility of the cable.

In order to illustrate the improvement of anti-interference capability brought by the wrapping method in the embodiment of FIG. 6, FIG. 7B shows a schematic view of a comparison of anti-interference capability between the cable in the embodiment of FIG. 6 and the cable in the embodiment of FIG. 4, where Figure (a) is the anti-interference capability of the cable in the embodiment of FIG. 4, and Figure (b) is the anti-interference capability of the cable in the embodiment of FIG. 6.

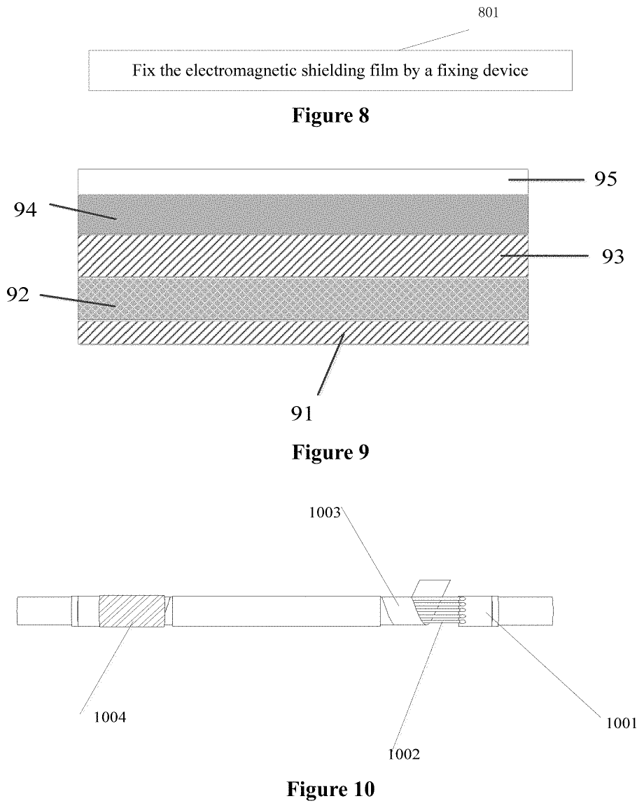

Based on the embodiment described in FIGS. 1 to 6, after the electromagnetic shielding film is wrapped on the connected bare cable core conductor, the method further includes the following steps. Referring to FIG. 8, another embodiment of the method for connecting the cable to the connector is provided according to an embodiment of the present application, and the method includes the follow step 801.

In 801, the electromagnetic shielding film is fixed by a fixing device.

In order to improve the tightness between the electromagnetic shielding film and the cable core conductor, the electromagnetic shielding film can further be fixed by the fixing device to ensure the compactness between the cable core conductor and the electromagnetic shielding film, so that the electromagnetic waves can perform fast attenuation and guiding out through the electromagnetic shielding film.

Preferably, when the electromagnetic shielding film is fixed by the fixing device, it is generally preferred that the electromagnetic shielding film is fixed to the cable core conductor by a tinplate. In order to prevent the tinplate from loosening during use, the tinplate can further be filled with glue for finalizing, so as to increase the reliability of the connection between the tinplate and the electromagnetic shielding film.

In the embodiment of the present application, the fixing method and the fixing device of the electromagnetic shielding film are described in detail, which improves the reliability of the connection between the cable core conductor and the connector in the embodiment of the present application.

It should be noted that, based on the same wrapping method in FIG. 2, FIG. 4 or FIG. 6, in order to improve the anti-interference capability of the cable, a second metal layer D can further be arranged between the conductive layer B and the protective film C of the electromagnetic shielding film for assisting the conductive layer B to perform shielding. Since the second metal layer D is arranged between the conductive layer B and the protective film C, the guiding speed for the electromagnetic waves can be accelerated, so that the electromagnetic waves can be rapidly brought out of the cable to better avoid the interference of the electromagnetic waves on the cable core conductor. Therefore, in a case that the cable with connectors needs a higher signal transmission speed or a higher transmission power, the second metal layer D can be arranged between the conductive layer B and the protective film C to increase the conduction effect of the second metal layer on the electromagnetic waves, so that the anti-interference capability of the core conductor is improved. FIG. 9 shows a schematic structural view of the electromagnetic shielding film, where A is the first metal layer, B is the conductive layer, D is the second metal layer, and C is the protective film.

Optionally, the thickness of the second metal layer D ranges from 5 to 50 micrometers. Since the thickness of the second metal layer directly affects the conduction effect for electromagnetic waves, the second metal layer with different thicknesses may be used according to requirements for anti-interference capability of the cable core conductor.

In order to facilitate the connection between the electromagnetic shielding film and the fixing device, a glue layer E, such as a water-based hot melt glue layer, or a silk-screen hot melt glue layer, can further be arranged on an outer side of the protective film C. The glue layer can also be omitted if it is not necessary. The glue layer is mainly arranged according to actual needs, which is not specifically limited hereto.

Further, besides metal particles and polyurethane carrying the metal particles, the conductive layer of the electromagnetic shielding film in the present application further includes a certain proportion of curing agent for curing liquid product. When the polyurethane is made into a solution and coated, the curing agent cures the polyurethane, and the content of the curing agent in the conductive layer generally ranges from 5% to 15%.

In addition, the conductivity of the metal particles in the conductive layer directly affects the guiding out and attenuation of the electromagnetic waves. Therefore, the conductive particles in the conductive layer are generally selected from metal particles with better conductivity such as gold, silver, copper, nickel, and aluminum. The mass proportion of metal particles also directly affects the conductivity of the conductive layer. The larger the mass proportion of metal particles is, that is, the denser the metal particles is, the stronger the conductivity to the electromagnetic waves is, while the smaller the mass proportion of metal particles is, the sparser the metal particles is, that is, the weaker the conductivity to the electromagnetic waves is. Therefore, the mass proportion of the metal particles in the conductive layer can be adjusted according to the anti-interference ability needed by the cable core conductor. Preferably, the mass proportion of the metal particles in the conductive layer ranges from 1% to 80%. In a case that the thickness and composition of each layer of the electromagnetic shielding film are the same, the anti-interference capability of the cable core conductor may range from 40 dB to 100 dB, and the maximum anti-interference capability may reach 103 dB.

The method for connecting the cable to the connector in the embodiments of the present application is described above, and the cable in the embodiments of the present application is described as follows. Referring to FIG. 10, according to an embodiment of the cable in the embodiments of the present application, the cable includes:

a connector 1001, a cable core conductor 1002 connected to the connector 1001;

and an electromagnetic shielding film 1003, where the electromagnetic shielding film 1003 is configured to wrap the cable core conductor 1002.

Preferably, the electromagnetic shielding film is configured to wrap on a connection between the cable core conductor and the connector.

Preferably, the electromagnetic shielding film is arranged between the cable core conductors of the pair of cable core groups in the cable to wrap the cable core conductors.

Preferably, the electromagnetic shielding film is configured to wrap on an outer side of each cable core conductor in the cable.

Preferably, the cable further includes a fixing device 1004 for fixing the electromagnetic shielding film.

Preferably, the fixing device is a tinplate.

It should be noted that the cable connected to the connector in the embodiments of the present application is made based on the method described in the embodiments of FIGS. 1 to 8, and reference may be made to embodiments of FIGS. 1 to 8 for the function of each portion and the anti-interference capability of the cable, which will not be described here.

A schematic view of test result of the anti-interference capability of the cable after the cable is connected to the connector using the connection method in the embodiment is described as follows.

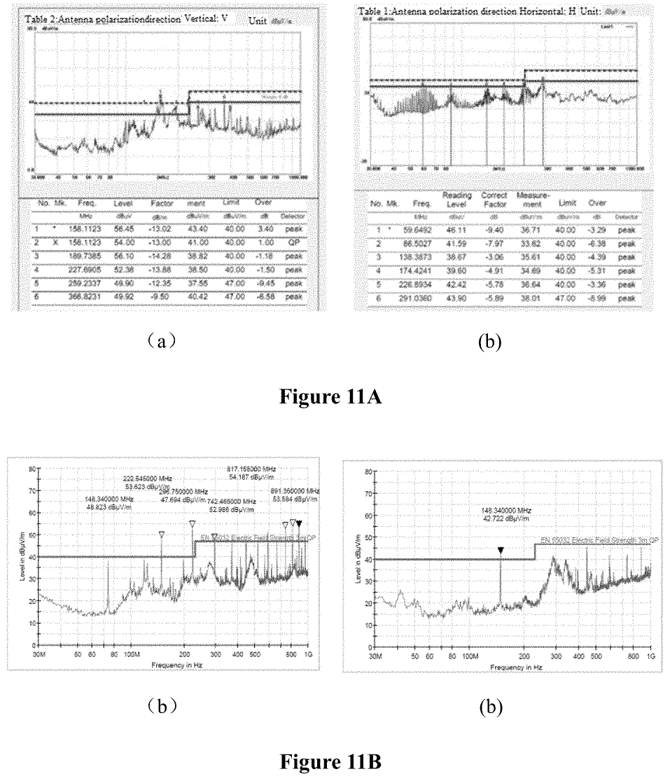

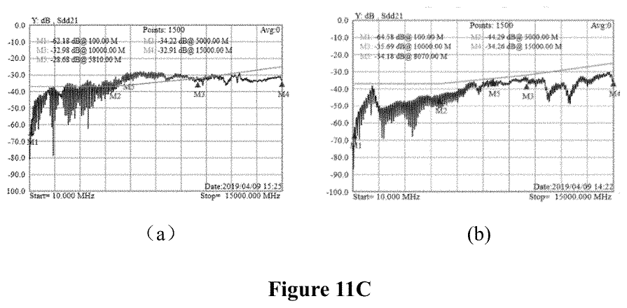

As shown in FIG. 11, FIGS. 11A, 11B, and 11C are views of a comparison of shielding effect between a 24-core industrial control data cable connected to the connector using and without using the connection method provided according to the embodiment, between an HDMI data transmission cable connected to the connector using and without using the connection method provided according to the embodiment, and between an USB 3.1 data and power transmission cable connected to the connector using and without using the connection method provided according to the embodiment. In FIG. 11A, Figure (a) is a view of shielding effect of the 24-core industrial control data cable without using the connection method in the embodiment, and Figure (b) is a view of shielding effect of the 24-core industrial control data cable using the connection method in the embodiment, where the test data in Figure (a) shows that a line shape of the entire test wave band has obvious beating, and exceeds the first standard line (shown by the solid line) in multiple areas, and exceeds the second standard line (shown by the dotted line) in some wave bands, so product shown in the Figure (a) is unqualified; while the test data in Figure (b) shows that a line shape of the entire test wave band has obviously stable beating, and is under the first standard line (shown by the solid line) in all wave bands, and does not exceed the second standard line, so product shown in the Figure (b) is qualified.

In FIG. 11B, Figure (a) is a view of shielding effect of the HDMI data transmission cable without using the connection method in the embodiment, and Figure (b) is a view of shielding effect of the HDMI data transmission cable using the connection method in the embodiment, where the test data in Figure (a) shows that a line shape of the entire test wave band has obvious beating, and exceeds the standard line in multiple areas, so product shown in the Figure (a) is unqualified; while the test data in Figure (b) shows that a line shape of the entire test wave band has stable beating, and does not exceed the standard line, so product shown in the Figure (b) is qualified.

In FIG. 11C, Figure (a) is a view of shielding effect of the USB 3.1 data and power transmission cable without using the connection method in the embodiment, and Figure (b) is a view of shielding effect of the USB 3.1 data and power transmission cable using the connection method in the embodiment, where the test data in Figure (a) shows that a line shape of the entire test wave band has obvious beating, and exceeds the standard line in multiple areas, so product shown in the Figure (a) is unqualified; while the test data in Figure (b) shows that a line shape of the entire test wave band has stable beating, and does not exceed the standard line, so product shown in the Figure (b) is qualified.

In addition to the above types of tests, all cables using the connection method of the present application can pass the corresponding cable test, which will not be listed here.

Those skilled in the art may clearly understand that, for convenience and brevity of description, for a detailed working process of the foregoing system, apparatus and unit, reference may be made to a corresponding process in the foregoing method embodiments, which is not repeated herein.

In the embodiments according to the present application, it should be understood that the disclosed system, device and method may be implemented in other forms. For example, the embodiments of the device described above are only schematic. For example, the division of the units is only a division according to logical function, and there may be other division modes in the practical implementation, for instance, multiple units or components may be combined, or may be integrated into another system; and some features may be omitted or may not be performed. In addition, the coupling between the components, direct coupling or communication connection displayed or discussed above may be realized by some interfaces, or indirect coupling or communication connection of devices or units, and may be electrical, mechanical or of other forms.

Heretofore, the above embodiments are merely provided for describing the technical solutions of the present application, rather than limiting the present application. Although the present application is described in detail with reference to the foregoing embodiments, those skilled in the art should understand that they can still modify technical solutions described in the foregoing embodiments or make equivalent substitutions to some of the technical features, and that such modifications or substitutions deviate the essence of the corresponding technical solutions from the spirit and scope of the embodiments of the present application.

1. A method for connecting a cable to a connector, comprising:
baring a cable core conductor with a predetermined length in the cable;
connecting the cable core conductor to the connector;
wrapping the connected bare cable core conductor with an electromagnetic shielding film to effectively reduce signal crosstalk between cable cores, wherein the electromagnetic shielding film comprises at least a first metal layer, a conductive layer and a protective film;
the first metal layer is configured to shield electromagnetic interference;
the conductive layer is arranged on the first metal layer, and is configured to shield electromagnetic interference; and
the protective film is arranged on the conductive layer, and is configured to provide protection for the electromagnetic shielding film.

2. The method according to claim 1, wherein the wrapping the connected bare cable core conductor with the electromagnetic shielding film comprises:
wrapping the electromagnetic shielding film on a connection between the cable core conductor and the connector.

3. The method according to claim 1, wherein the wrapping the connected bare cable core conductor with the electromagnetic shielding film comprises:
arranging the electromagnetic shielding film between the cable core conductors of a pair of cable core groups in the cable; and
wrapping the cable core conductors with the electromagnetic shielding film.

4. The method according to claim 1, wherein the wrapping the connected bare cable core conductor with the electromagnetic shielding film comprises:
wrapping the electromagnetic shielding film on an outer side of each cable core conductor in the cable.

5. The method according to claim 1, further comprising:
fixing the electromagnetic shielding film by a fixing device.

6. The method according to claim 5, wherein the fixing device is a tinplate.

7. A cable connected to a connector, wherein the cable is made by the method according to claim 1, and the cable comprises:
a connector, a bare cable core conductor connected to the connector;
and an electromagnetic shielding film, wherein the electromagnetic shielding film is configured to wrap the bare cable core conductor;
the electromagnetic shielding film comprises at least a first metal layer, a conductive layer and a protective film;
the first metal layer is configured to shield electromagnetic interference;
the conductive layer is arranged on the first metal layer, and is configured to shield electromagnetic interference; and
the protective film is arranged on the conductive layer, and is configured to provide protection for the electromagnetic shielding film.

8. The cable according to claim 7, wherein the electromagnetic shielding film is configured to wrap on a connection between the cable core conductor and the connector.

9. The cable according to claim 7, wherein the electromagnetic shielding film is arranged between the cable core conductors of a pair of cable core groups in the cable to wrap the cable core conductors.

10. The cable according to claim 7, wherein the electromagnetic shielding film is configured to wrap on an outer side of each cable core conductor in the cable.

11. The cable according to claim 7, further comprising a fixing device for fixing the electromagnetic shielding film.

12. The cable according to claim 11, wherein the fixing device is a tinplate.
